(19) United States
(12) Patent Application Publication
(10) Pub. No.: US 2014/0100973 A1
(43) Pub. Date: Apr. 10, 2014

(54) SMARTPHONE VIRTUAL PAYMENT CARD

(71) Applicant: CRYPTITE, LLC, PORTOLA VALLEY, CA (US)

(72) Inventors: Kerry D. Brown, PORTOLA VALLEY, CA (US); RONALD P. KNAPP, LOS ALTOS, CA (US); RICHARD B. MAIN, NEWARK, CA (US)

(73) Assignee: CRYPTITE, LLC, PORTOLA VALLEY, CA (US)

(21) Appl. No.: 14/098,840

(22) Filed: Dec. 6, 2013

Related U.S. Application Data
(63) Continuation-in-part of application No. 12/752,390, filed on Apr. 1, 2010.
Application No. 12/752,390 is a continuation-in-part of application No. 12/983,186, filed on Dec. 31, 2010, now Pat. No. 8,224,293.
Application No. 12/983,186 is a continuation-in-part of application No. 13/225,188, filed on Sep. 2, 2011.
Application No. 13/225,188 is a continuation-in-part of application No. 13/549,454, filed on Jul. 14, 2012.
Application No. 13/549,454 is a continuation-in-part of application No. 12/647,713, filed on Dec. 28, 2009, now abandoned.
Application No. 12/647,713 is a continuation-in-part of application No. 13/982,588.
(60) Provisional application No. 61/735,707, filed on Dec. 11, 2012.

(51) Int. Cl. G06Q 20/32; G06Q 20/20

(52) U.S. Cl. CPC G06Q 20/3274; G06Q 20/204
USPC 705/17

(57) ABSTRACT

A payment device presents a matrix barcode on a smartphone display screen for scanning by a merchant at a point-of-sale terminal. The consumer authenticates with their payment processor by logging in with their smartphone through a back channel. A successful log-in is rewarded with a matrix barcode the consumer can allow the merchant to scan if the particulars and price of the proposed transaction are acceptable. A transaction summary and request for approval arrive back at the consumer's smartphone through the back channel. Approval can be indicated by the entry of a user PIN code, and the transaction is complete.

### CO-PENDING APPLICATIONS

This application claims benefit of U.S. Provisional Patent Application 61/735,707, filed Dec. 11, 2012, and titled HIGH SECURITY MULTI-PERSONALITY MAGNETIC CARD AND APP;

and this application is a Continuation-in-Part of U.S. patent application Ser. No. 12/752,390, filed Apr. 1, 2010, and titled MAGNETIC EMISSIVE USE OF PRELOADED SECRET-KEY ENCRYPTED USE-ONCE PAYMENT CARD ACCOUNT NUMBERS;

and it is also a Continuation-in-Part of U.S. patent application Ser. No. 12/983,186, filed Dec. 31, 2010, and titled ENCODED COLORGRAM FOR MOBILE DEVICE SECURITY, now U.S. Pat. No. 8,224,293, issued Jul. 17, 2012;

and it is also a Continuation-in-Part of U.S. patent application Ser. No. 13/225,188, filed Sep. 2, 2011, and titled OPTICAL CONTACT LOADED MAGNETIC CARD;

and it is also a Continuation-in-Part of U.S. patent application Ser. No. 13/549,454, filed Jul. 14, 2012, and titled TRACEABLE AND NON-REPUTABLE TRANSACTION DEVICES AND METHODS, and which itself was a CIP of U.S. patent application Ser. No. 12/647,713, filed Dec. 28, 2009, titled VIRTUALIZATION OF AUTHENTICATION TOKEN FOR SECURE APPLICATIONS, now abandoned;

and it is further a Continuation-in-Part of U.S. patent application Ser. No. 13/932,588, filed Jul. 1, 2013, and titled CHARACTERISTICALLY SHAPED COLORGRAM TOKENS IN MOBILE TRANSACTIONS.

All are fully incorporated herein by reference.

### BACKGROUND OF THE INVENTION

1. Field of the Invention

The present invention relates to electronic payment methods that can be presented by consumers, and more particularly to those readily adapted to by common point-of-sale (POS) and their barcode scanners.

2. Description of Related Art

Recent advances in smartphone technology and their ubiquity throughout the world now allows banks and credit card issuers to issue transaction authorizations in realtime at the points-of-sale. This was never before possible, and the financial institutions had to rely on secure credentials like smartcards.

Practically all of the proposed high technology solutions to make credit cards smarter and more secure have been thwarted by the inability or outright unwillingness of merchants around the world to upgrade their merchant terminals to work with the new gadgets. Consumers too have been balking at being required to do much more than to hand their card to a merchant to complete a purchase.

The days of swiping embossed credit cards in machines to produce carbon paper copies for signing are almost completely gone. Hotels still use them, although they are rapidly disappearing, often driven by the shift to printed payment cards, rather than embossed. Going too are the days where cashiers type in prices they find stamped on each product by stocking clerks. Some third-world retail locations still use clerks rather than the more expensive scanning technology. All manufacturers are now required to print Universal Product Codes (UPC) on their labels that can be electronically scanned at checkout and matched with the daily prices. These even help with keeping local inventories balanced because sales are so well monitored and accounted for.

UPC barcode symbols are now used universally in retail stores in the United States, Canada, the United Kingdom, Australia, New Zealand and in other countries to track items from loading dock receipt to end user sale, including return merchandise procedures. The most common, UPC-A, uses twelve numerical digits encoded in a familiar strip of black bars and white spaces to uniquely identify each product type/size at the point of sale. The original twelve numerical digits are also repeated in plaintext in case manual entry is required at the POS terminal.

UPC barcodes are one-dimensional and not capable of communicating very much information. A whole new raft of matrix barcodes are now making their appearance around the world, with the so-called “QR-Code” being a very popular one. These new matrix barcodes can convey much more information and can direct a user to a website on the Internet if it can be read-in by a camera or scanner.

The QR-Code, originally Quick Response Code, is a trademark for a type of two-dimensional or matrix barcode first intended for the automotive industry in Japan. Information encoded by a QR-Code can include numeric, alphanumeric, binary, and Kanji. This can be extended to support almost any type of data. The QR-Code system provides faster readability and greater storage capacity compared to standard UPC barcodes. QR-Code applications now include product tracking, item identification, time tracking, document management, general marketing, and much more.

Each QR-Code arranges square or round dots in a square grid on a white background, data is extracted from both vertical and horizontal patterns encoded.

Cryptite LLC has patented a 3D matrix barcode it calls a Colorgram™. It encodes data in a third dimension into the colors of each cell in a two-by-two matrix. Colorgrams visually encode data in the cells from a standard palette of colors arranged in a grid, radial pattern, matrix, or other predetermined pattern. The color-coded cells themselves can be circles, squares, rectangles, ovals, or practically any other shape. A self-calibration subfield includes a color cell from each of the standard palette of colors. If there are eight colors used in the standard palette, then there will be eight colored cells in the self-calibration subfield. These are arranged in a matrix in a standard way such that they can easily be recognized together as a self-calibration subfield by an application software (app) installed on the smartphone. A shape-outline of a logo, rainbow, etc., can include a color matrix, and such seems very significant since Google began stuffing matrices into outline shapes.

Environmental and product variations in the image capture of colorgram with smartphone can often produce large uncertainties in determining which colors in the standard palette of colors each colored cell in colorgram represents. Application software includes subroutines that register each of the color cells imaged in self-calibration subfield as the possible choices, and each color cell from the colorgram is compared to test which standard color is the closest match. The decisions can be reached quickly and with very few reading errors.

Authentication factors are used to confirm or verify the identity of a cardholder. Strong, two-factor authentication employs two different authentication factors to increase the level of security beyond what is possible with only one of the constituents. For example, one kind of authentication factor can be what-you-have, such as electromagnetic stripe credit card or the SIM card typical to many mobile devices and personal trusted device (PTD). The second authentication factor can be what-you-know, such as the PIN code that you enter at an ATM machine. Using more than one authentication factor is sometimes called “strong authentication” or “multi-factor authentication,” and generally requires the inclusion of at least one of a who-you-are or what-you-have authentication factor.

### SUMMARY OF THE INVENTION

Briefly, a payment device embodiment of the present invention presents a matrix barcode on a smartphone display screen for scanning by a merchant at a point-of-sale terminal. The consumer authenticates with their payment processor by logging in with their smartphone through a back channel. A successful log-in is rewarded with a matrix barcode the consumer can allow the merchant to scan if the particulars and price of the proposed transaction are acceptable. A transaction summary and request for approval arrive back at the consumer's smartphone through the back channel. Approval can be indicated by the entry of a user PIN code, and the transaction is complete.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1A is a functional block diagram and schematic of a retail payment system embodiment of the present invention, and shows a general configuration in which a user is able to use their smartphone to display a payment token or credential to a scanner at a merchant point-of-sale terminal;

FIG. 1B is another functional block diagram and schematic of the retail payment system embodiment of FIG. 1A, and shows a situation in which a user has presented a number of products for purchase, the scanner at a merchant point-of-sale terminal is used to scan in the UPC symbols;

FIG. 1C is the next functional block diagram and schematic of the retail payment system embodiment of FIG. 1A, and shows the point in which the user has obtained a payment token on their smartphone and is displaying it to the scanner at a merchant point-of-sale terminal is used to scan in the 2D matrix barcode;

FIG. 1D is the final functional block diagram and schematic of the retail payment system embodiment of FIG. 1A, and shows the point in which the user is asked to confirm the transaction on their smartphone and the issuing bank communicates payment authorization back to the merchant point-of-sale terminal;

FIG. 2 is a functional block diagram and schematic of a retail payment system embodiment similar to that of FIGS. 1A-1D, but with the addition of a printer and 2D matrix barcode checks;

FIGS. 3A-3B are flowchart diagrams showing the registration and payment transaction interactions of software installed on user smartphone, an issuing bank and payment processor, and a merchant point-of-sale terminal;

FIGS. 4A and 4B are functional block diagrams an electronic transaction security method 400 authenticating transfers between independent users each equipped with a personal trusted device. Such was originally disclosed in one Parent Application, U.S. patent application Ser. No. 13/932,588, filed Jul. 1, 2013, and titled CHARACTERISTICALLY SHAPED COLORGRAM TOKENS IN MOBILE TRANSACTIONS;

FIG. 5 is a functional block diagram of an encoded colorgram system application that demonstrates a practical and important use of the colorgram technology. Such was originally disclosed in one Parent Application, now U.S. Pat. No. 8,224,293, issued Jul. 17, 2012, titled ENCODED COLORGRAM FOR MOBILE DEVICE SECURITY;

FIG. 6 is front view diagram of a colorgram embodiment of the present invention that includes a rectangular 9×6 matrix data field decorated with a predetermined physical pattern of colored cells; and

FIG. 7 is a functional block diagram of a restaurant guest payment system that includes app embodiments of the present invention for mobile smartphones and POS tablets.

### DETAILED DESCRIPTION OF THE INVENTION

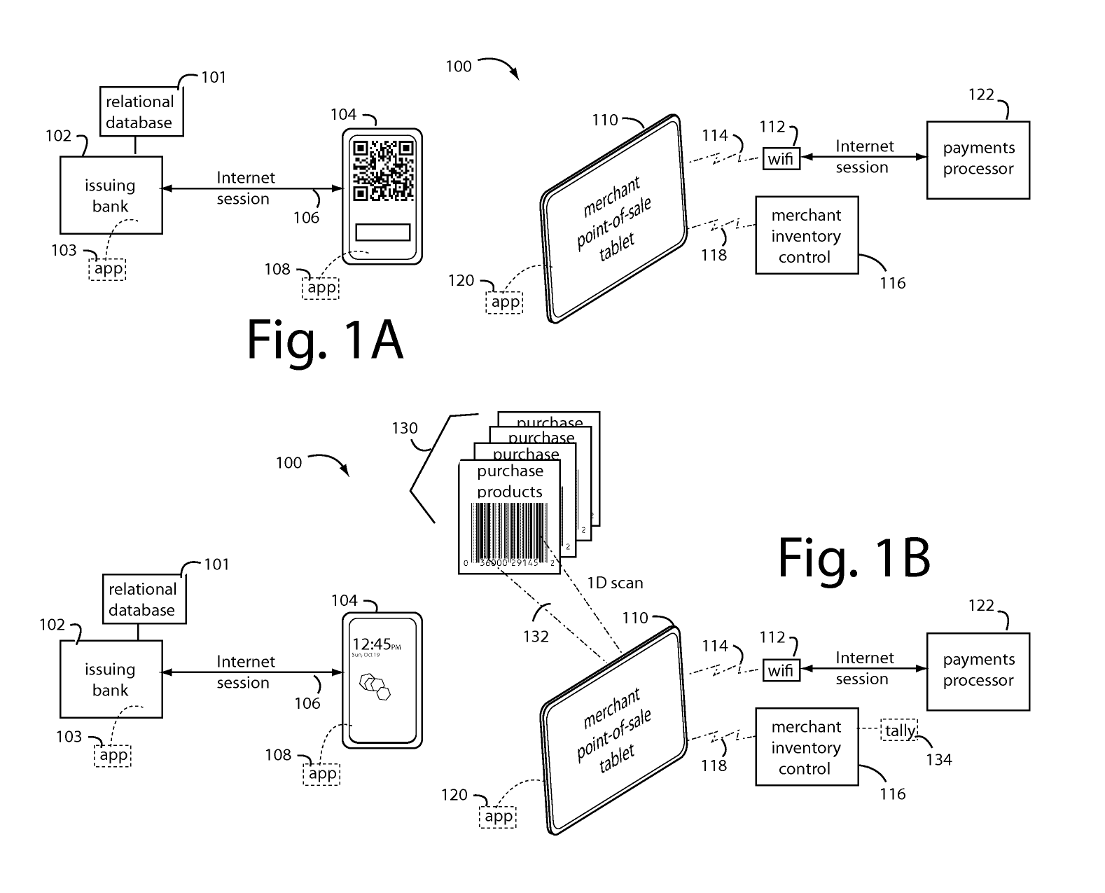

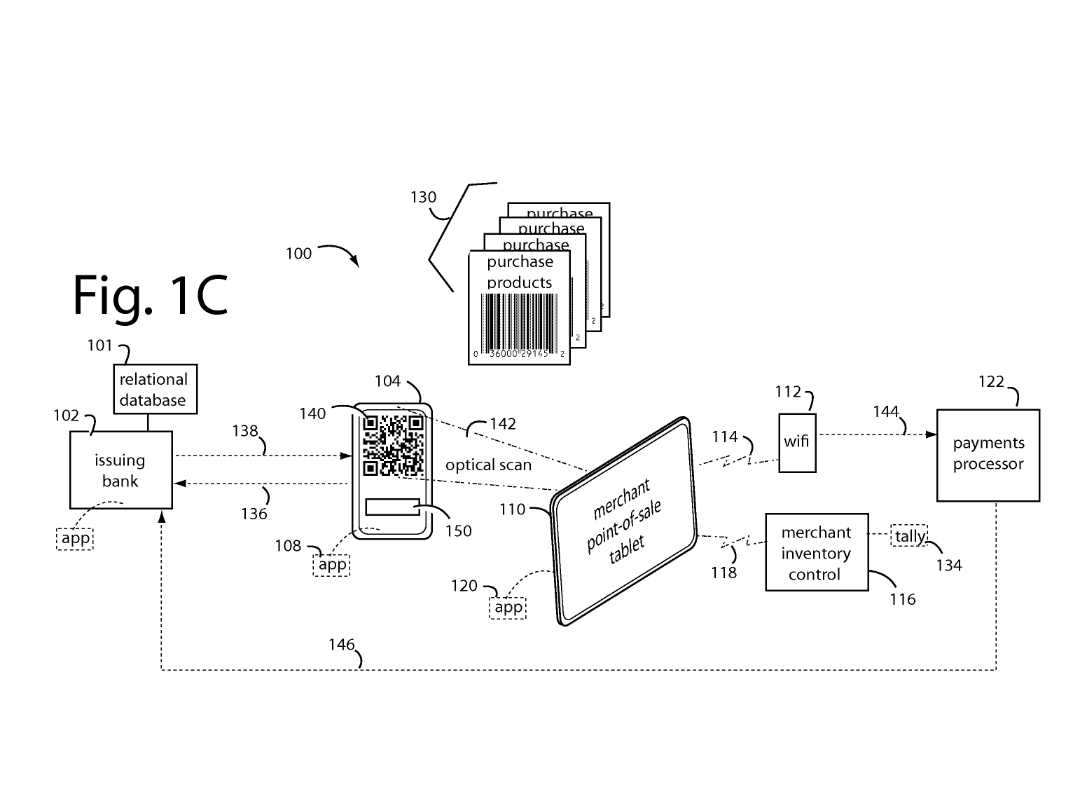

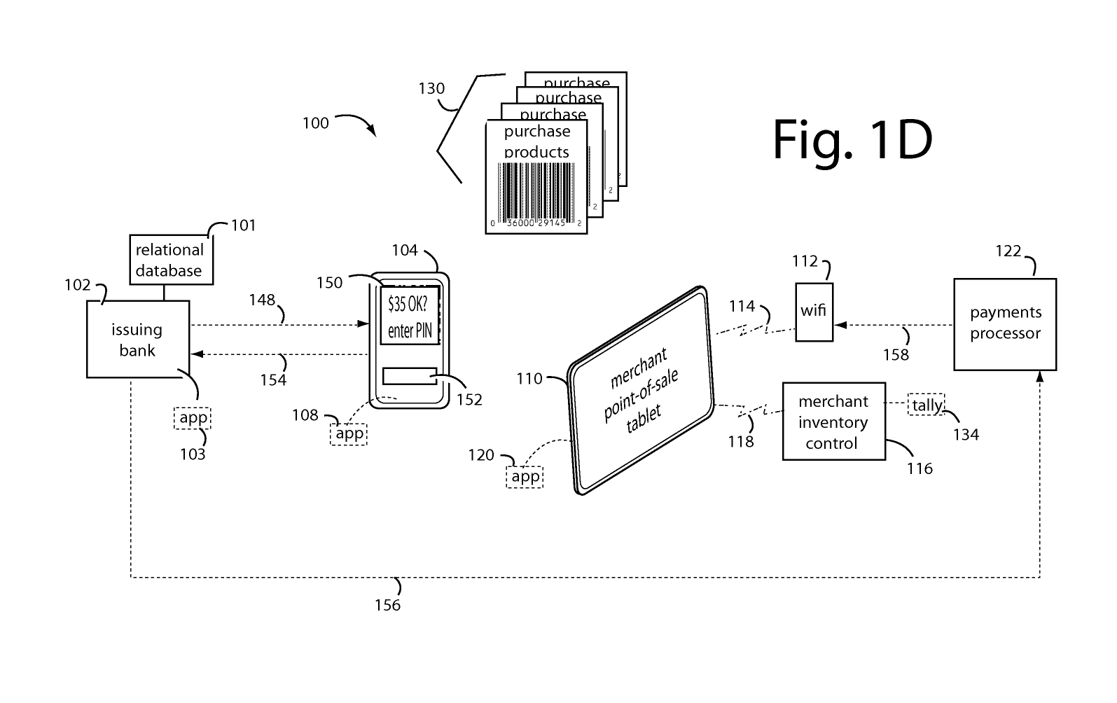

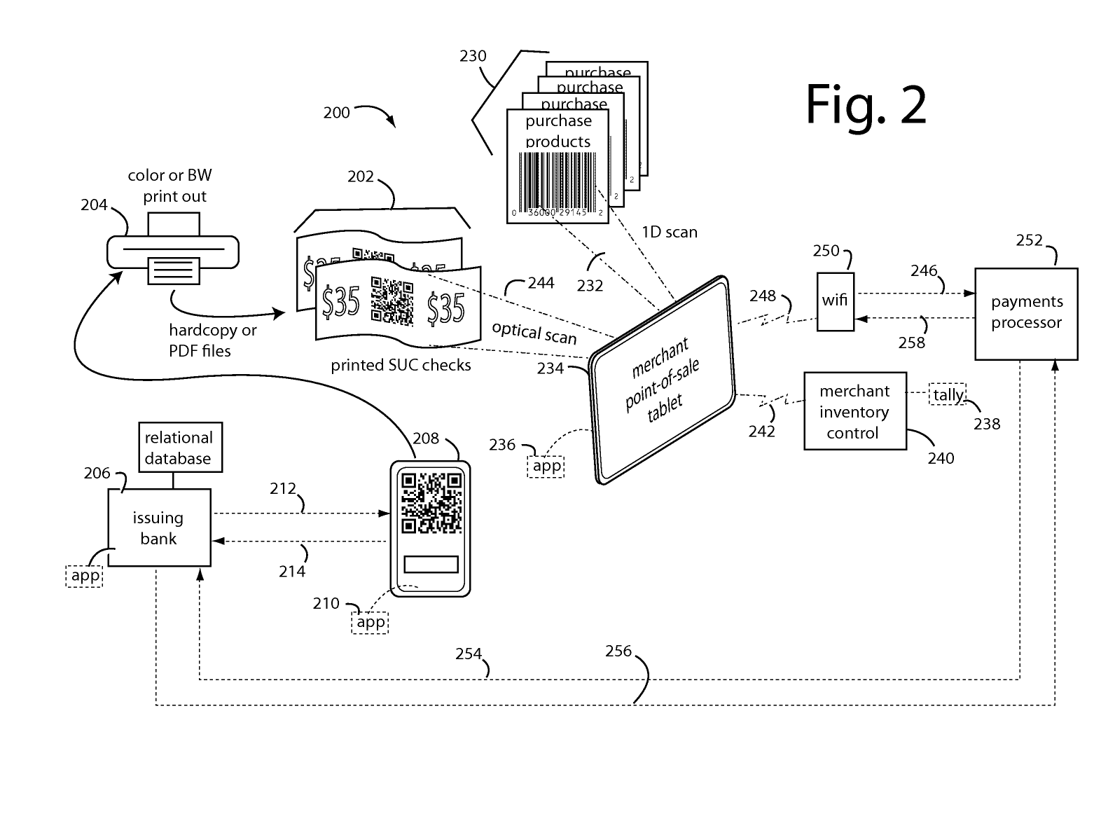

FIGS. 1A-1D represent a retail payment system embodiment of the present invention, and is referred to herein by general reference numeral 100. In general, the electronic and network hardware employed is widely available and already in the hands of end users. The characterizing function components comprise software applications installed on consumer devices, merchant terminals, and payment processor back-ends.

FIG. 1A represents a general configuration for retail payment system 100. A secure, relational database 101 is installed at an issuing bank 102 with a payments processing application 103. These provide deposit, credit, debit and other payment account and corresponding electronic credentials to consumers and other uses. Each such consumer and user have a mobile personal trusted device 104 like a smartphone that can access the Internet through conventional mobile 4G type connections, WiMax, or WiFi through a wireless connection 106. A user app 108 is installed in the operating system, e.g., Android type, of mobile personal trusted device 104. User app 108 provides the processor functionality needed for the mobile personal trusted device 104 to contact the issuing bank 102 to fetch electronic credentials in realtime as needed.

A retail merchant who maintains a place of business in a brick-and-mortar building or a website on the Internet sells products and accepts electronic, debit card, or credit card payments.

In this case such merchants install a tablet device 110 with a camera and wireless communication capabilities at their points-of-sale. Such tablets function like older and more conventional cash registers with UPC scanners and credit card readers, but are much less expensive to acquire and use. Nevertheless, the older and more conventional cash registers with UPC scanners and credit card readers could be used here instead of the tablet device 110. A Wi-Fi router 112 provides a wireless link 114 through to the Internet. A merchant inventory control 116 provides a database of retail product descriptions, inventory quantities, and prices. These are accessible to the tablet device 110 by a wireless link 118.

A merchant app 120 is installed in the operating system e.g., Android type of tablet device 110. App 120 provides all the functionality needed for the tablet device 110 to optically scan UPC symbols, tally product purchases, total and apply tax, adjust inventory records, and contact a payments processor 122 for transaction authorizations.

FIGS. 1B-1D represent how a consumer would go shopping at a brick-and-mortar retail merchant location, how the merchant would tally the sale, how the consumer would pay for their purchase, and how the payment transaction would be authorized and completed.

FIG. 1B illustrates the beginning of a transaction in which a number of products displaying UPC symbols 130 are submitted to a 1D-scan 132. Merchant app 120 thus builds a tally 134 ending with a payment total. When the merchant is satisfied tally 134 is correct, they ask the consumer for payment.

FIG. 1C illustrates the next step in the transaction. When the user is ready to complete a purchase and pay for it, they use their smartphone 104 to contact the issuing bank 102 with a payment request 136 under the direction of user app 108. Issuing bank 102 responds with a graphic file 138 of a matrix barcode 140 equivalent to a Cryptite COLORGRAM or a QR-Code. Issuing bank 102 could rely on the single factor authentication of recognizing that smartphone 104 is a device registered to an active payment account, or it can instruct user app 108 to provide another factor for stronger authentication. In any event, it would be best not to burden the user with delays or demands for information. For example, facial recognition, mobile carrier log on status, geo-fencing, or coincidence with an authorized merchant location can be added into the security factor mix.

The matrix barcode 140 displayed is available for a 2D scan 142 by the merchant tablet 110. The matrix barcode 140 is encoded with identification codes for the user, the issuing bank, and their Internet or other network access. Each 2D-scan 142 by the merchant tablet 110 of matrix barcode 140 triggers merchant app 120 to combine the user account information and tally 134 to be packed into a payment processor request 144. This, and others, are amalgamated according to merchant app 120 into a transaction authorization request 146 for the respective issuing banks 102 to approve or decline.

FIG. 1D represents when the issuing banks 102 receive transaction authorization request 146. They respond by reviewing the transaction and the consumer's payment account. If the transaction and user so far seem to be authentic, a transaction summary 148 is sent to user app 108 for handling. Such puts up a transaction summary display 150 that asks the user if the amount is OK. If so, it requires a user PIN 152 to be entered. The PIN can be authenticated locally by user app 108, or better it is encrypted by user app 108 and forwarded back to issuing bank 102 in a PIN message 154.

Issuing bank 102 decodes the encrypted PIN message 154 and if all is proper, a transaction authorization message 156 is returned to the payments processor 122. The merchant is notified in a payment message 158. Merchant app 120 then displays success on tablet 110 and issues a purchase receipt.

In an alternative embodiment in which the smartphone 104 can lack immediate and continuing access to the Internet, issuing bank 102 can be requested to send a cache of single-use-code matrix barcodes 140. These are securely stored in smartphone 104, FIG. 1C and sequentially made available for use in future transactions by user app 108. It would probably be best to embed limits within each matrix barcode 140 that restrict when, where, and how such can be used, and what sort of security factors or challenges should be invoked when used to prevent fraud.

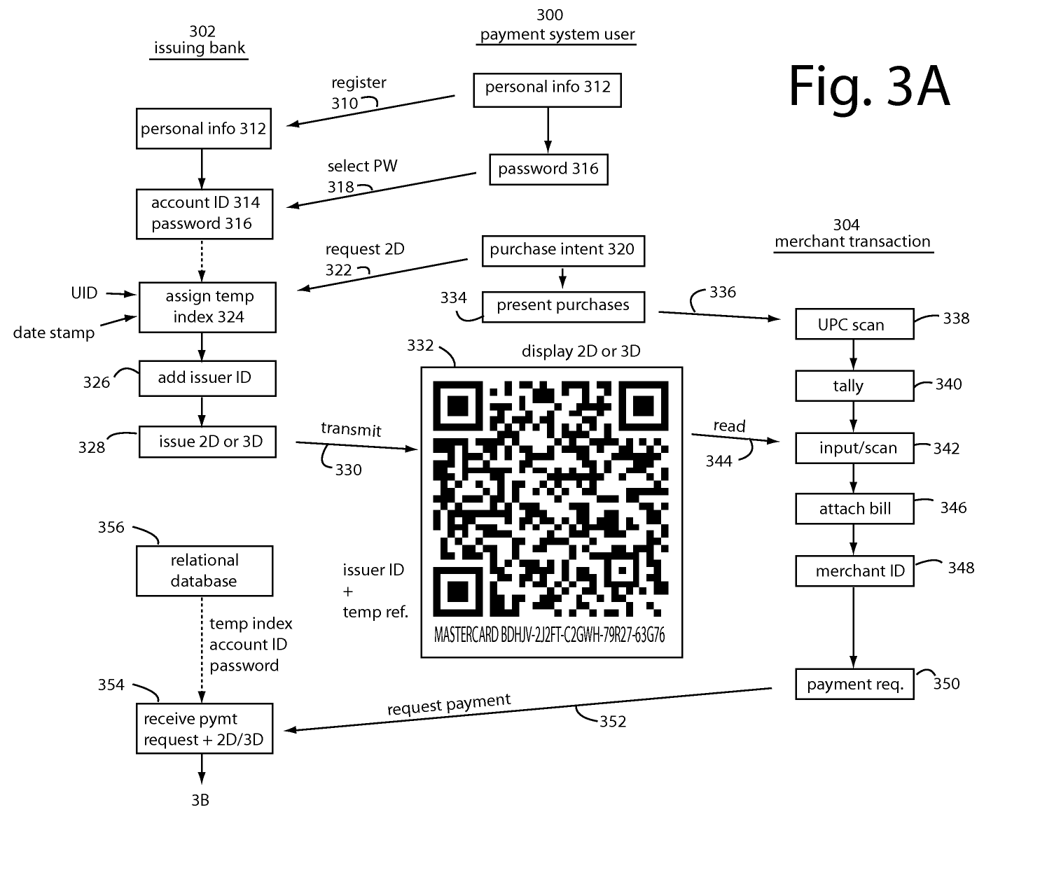

FIG. 2 represents a retail payment system embodiment of the present invention, and is referred to herein by general reference numeral 200. While similar in overall character to retail payment system 100, this embodiment is based on the use of matrix barcode checks 202 printed on paper or electronically stored as a JPG image file. Such matrix barcode checks 202 should be handled, protected, and kept from public view as if they were currency.

The matrix barcode checks 202 can be issued with a fixed value, e.g., $35, or a not-to-exceed value, and even with a restriction on who the payee can be. For example, the payee restrictions can be to named individuals, types of merchants like gas stations, particular utilities, kinds or services or products, etc. The payee restrictions can work the other way too, excluding individual things or classes.

Several matrix barcode checks 202, each with unique encodings for single-use-codes (SUC), are printed out in color or black-and-white (BW) by a printer 204. The matrix barcodes can be conventional QR-Codes, Cryptite COLORGRAMS, or equivalent. Such use is more fully disclosed by the Present Inventors in the Parent Applications, U.S. patent application Ser. No. 12/983,186, filed Dec. 31, 2010, and titled ENCODED COLORGRAM FOR MOBILE DEVICE SECURITY; and also, U.S. patent application Ser. No. 13/932,588, filed Jul. 1, 2013, and titled CHARACTERISTICALLY SHAPED COLORGRAM TOKENS IN MOBILE TRANSACTIONS. These matrix barcode checks 202 can be carried in a man's wallet, mailed to grandchildren, used by third parties to pay bills, etc.

The matrix barcode checks 202 essentially function as conventional bank checks except that they never physically need to pass through and be processed by the Federal Reserve clearing system. Interestingly, nearly all the conventional checks the Federal Reserve Banks process now for collection are handled as electronic check images.

One of the first steps in the electronification of checks was when magnetic ink character recognition (MICR) information in a line at the bottom of checks was allowed. An image of the check is stored and the MICR information is used to process the payment as an automated clearinghouse (ACH) transaction. The shift from paper to electronic format started in October 2004 under authority of the “Check Clearing for the 21st Century Act”. This facilitated electronic check collection by allowing a “substitute check” to serve as a negotiable instrument. The substitute check is a paper copy of the front and back of the original check, and is a legal equivalent of the original. Under Check 21, institutions that wish to process checks electronically may do so provided that if, in the process of collecting a check they encounter an institution that insists on receiving paper items, they provide that institution with a substitute check created from the electronic image file.

Once a matrix barcode check 202 is used in a deposit or a transaction, the printed copy is deactivated by issuing bank 206 and are worthless. So, their current status and worth must be verified by contacting the issuing bank 206.

A smartphone 208 can be used to verify the worth of existing matrix barcode checks 202 by scanning them, or used to cash in and deposit them, or to issue new ones via printer 204. A user app 210 installed on smartphone 208 provides all three functions. In a first scenario to verify the worth of existing matrix barcode checks 202 by scanning them, user app 210 allows a user to photo a matrix barcode check 202. A network message 212 is sent to issuing bank 206 by user app 210. The value and status of the matrix barcode check 202 is returned in a network message 214. In a second scenario to cash in and deposit an existing matrix barcode check 202, user app 210 directs a user to photo the particular matrix barcode check 202. The network message 212 is used to signal issuing bank 206 a request to deposit the value. A receipt for the deposit of matrix barcode check 202 is returned in network message 214. The rest of FIG. 2 illustrates how a consumer would go shopping at a brick-and-mortar retail merchant location, how the merchant would tally the sale, how the consumer would pay for their purchase, and how the payment transaction would be authorized and completed.

Each transaction starts by scanning the UPC symbols 230 now ubiquitous on all products in stores. These are submitted to a 2D-scan 232 by a merchant tablet 234 or more conventional point-of-sale (POS) terminal with a wireless handheld barcode scanner. A merchant app 236 thus builds a tally 238 ending with a payment total. When the merchant is satisfied tally 238 is correct, they ask the consumer for payment. An inventory processor controller 240 is used to price and keep track of inventories according to their UPC codes. Tablet 234 is able to access inventory process controller 240 by a local Wi-Fi connection 242.

When the user is ready to complete a purchase and pay for it, they present a matrix barcode check 202. The matrix barcode encoding payment information displayed for a 2D scan 244 by the merchant tablet 234. The matrix barcode from check 202 was previously encoded with identification codes for the user account, the issuing bank, and Internet or other network access routings. Each such 2D-scan 244 by the merchant tablet 234 triggers merchant app 236 to combine the user account information and tally 238 to be packed into a payment processor request 246 via a wireless link 248 and router 250 to a payment processor 252. This, and other transactions, are amalgamated according to merchant app 236 into a transaction authorization request 254 for action by the respective issuing banks 206. A normal response will be to approve or decline the transaction.

When the issuing banks 206 receive transaction authorization request 254 they respond by reviewing the transaction and the status of the particular matrix barcode check 202 then presented. Issuing bank 206 need not be in communication with smartphone 208 at that moment. A password could have been encoded into the matrix barcode check 202 originally, and the issuing bank can require it to be provided in transaction authorization request 254. Issuing bank 206 decodes the encrypted PIN in message 254 and if all is proper, a transaction authorization message 256 is returned to the payments processor 252. The matrix barcode check 202 is canceled and cannot be used again. The merchant is notified in a payment message 258 that the proposed transaction is approved or declined. Merchant app 236 then displays the results on tablet 234 and can issue a purchase receipt.

The matrix barcodes themselves do not contain any personally identifiable information (PII) about the user, not their name, not their account number, not their password, nothing. The matrix barcodes encode an issuer ID and a temporary reference index, e.g., MASTERCARD BDHJV-2J2FT-C2GWH-79R27-63G76. Such temporary reference index is totally meaningless to anyone but the MASTERCARD issuing bank. Even then, such temporary reference index has a limited life and a restricted geographic area of use. In the case of a matrix barcode fetch by the user for a card-present POS purchase, the life would be less than ten minutes and restricted to ten miles of the smartphone location at the time of issuance. And it could only be used once, and only by a qualified merchant. If the matrix barcode was printed out on a paper check, then the time to negotiate the check could be extended to a month, for example.

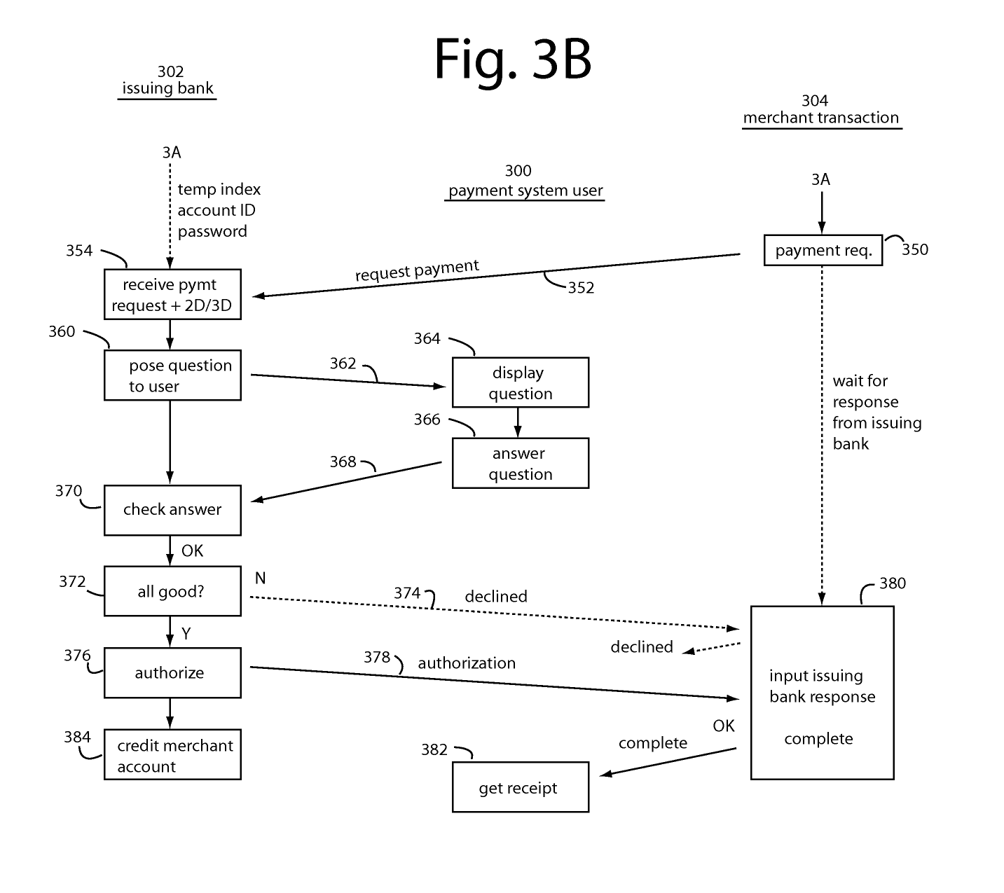

Referring now to FIG. 3A, the independently operating application software programs for a user 300, an issuing bank 302, and a merchant 304 all interact with one another to complete a transaction. User 300 registers with issuing bank 302 in a step 310. They provide personal information 312 and are assigned an account ID 314. Such personal information 312 can include the preregistration of a smartphone, email, SMS, etc. The user chooses a password 316 and sends the issuing bank their selection in a step 318.

All is quiet until the user 300 intends to make a purchase and requests a matrix barcode to be issued for display on a smartphone or to be printed on a check. An intent 320 is sent in a step 322. A step 324 assigns a temporary index number obtained from a random number generator (RNG) and logs its generation with a time stamp. A relational database stores the associations of account ID's to temporary index numbers. The RNG can produce a unique identifier (UID). A step 326 adds an Issuer ID. The combination is encoded and issued in a step 328 for a transmission 330 to the user as a 2D matrix barcode 332.

Several such unique 2D matrix barcodes 332 can be requested and delivered in one session if necessary.

The transmission 330 can and should be restricted to user devices that were preregistered, and only to geographical destinations and times that seem reasonable. Otherwise, a challenge can be issued to collect one more security factor from the user.

The user, in the meantime, gathers together their purchases and presents them to the merchant POS in a step 334. A UPC scan 336 by a POS scanner 338 captures the UPC symbols on the purchased products. A tally is computed in a step 340. A step 342 starts a 2D scan 344 of the 2D matrix barcode 332 when allowed and facilitated by the user, and thus provides the temporary index number and issuer ID. The issuer ID instructs the merchant as to where, who, and how to electronically direct a bill. A step 346 attaches the bill computed from the tally and demands payment from the user. A step 348 attaches a merchant ID so the issuing bank knows who is to be credited. A step 350 electronically requests payment via a payments processor from the issuing bank in a message 352 over a network connection. The recipient issuing bank 302 executes a step 354 to receive the payment request, and the bill, the merchant ID, and the temporary index number are decoded if encrypted.

A relational database 356 provides the associations of temporary index number 324 with user account ID 314 and their password 316 in a secure environment.

If each of several validity requests are passed, the process can continue. For example, are the payment request, the bill, the merchant ID, the user account, products, time, place, and the temporary index number all good? If not, the payment request is declined, and if fraud is detected a report is generated for law enforcement.

Referring now to continuing FIG. 3B, a step 360 poses a question to the user 300 via a preregistered device that asks for the password 316 (FIG. 3A) asks if the total to be paid is OK, and/or asks what is the total to pay as they understand it. A transmission 362 is used to trigger a display of the question in a step 364. An answer 366 is returned in a response 368. A step 370 checks the answers given. A step 372 looks at all the parameters as they stand, and checks to see if all is good. If not a declined message 374 is transmitted to the merchant 304.

If the user's device is off line or otherwise unavailable in realtime, the issuing bank 302 can decide on its own to proceed if the circumstances seem legitimate and the risks are small.

Otherwise, if OK, a step 376 authorizes the transaction and sends this as an authorization message 378 to a merchant process 380 waiting for the response. A receipt 382 is given to the user, and a step 384 credits the merchant's account with payment.

The principal advantages of the system described in FIGS. 3A and 3B are that the users' information is never exposed or handled anywhere other than in the secure environment of the issuing bank. Not even the payment processors are privy to the sensitive information. Strong, two-factor security is used at a minimum, and additional security factors can be brought in as necessary in realtime.

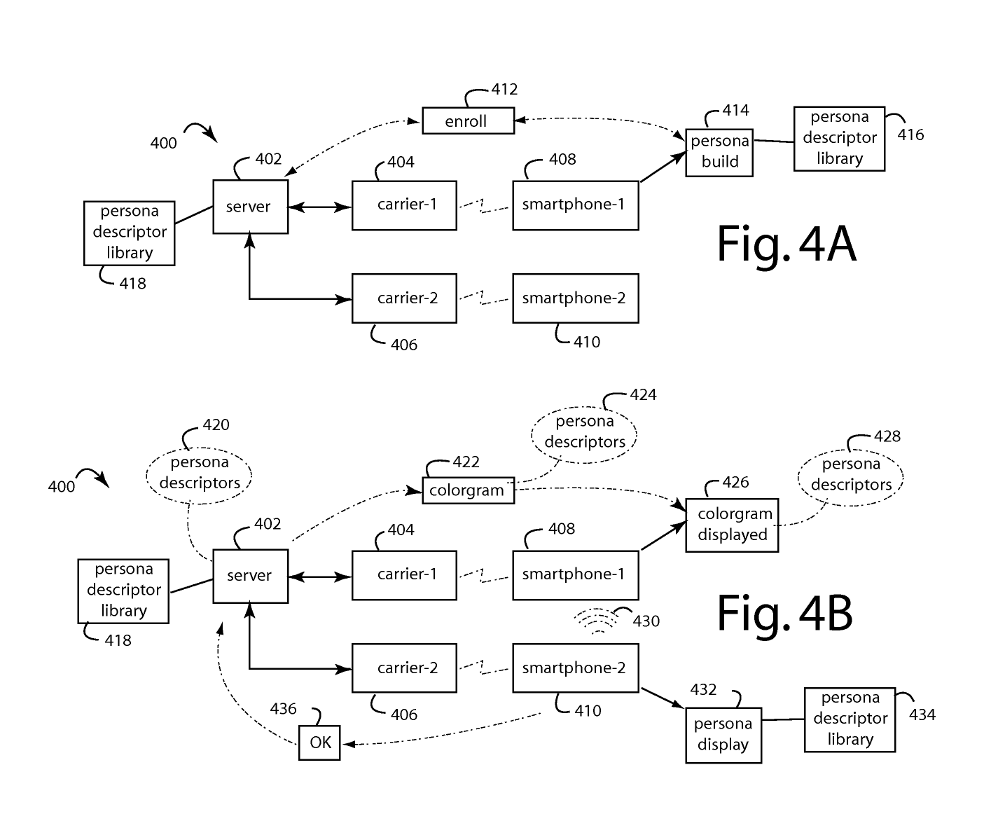

FIGS. 4A and 4B represent an electronic transaction security method 400 for authenticating transfers between independent users each equipped with a personal trusted device. Such was originally disclosed in one Parent Application, U.S. patent application Ser. No. 13/932,588, filed Jul. 1, 2013, and titled CHARACTERISTICALLY SHAPED COLORGRAM TOKENS IN MOBILE TRANSACTIONS. A network transaction server 402 is connected to communicate with a variety of communications networks like cellular carrier-1 404 and cellular carrier-2 406. These, in turn are able to independently communicate with mobile electronic devices such as smartphone-1 408 and smartphone-2 410. The basic hardware and functioning of the network server, carriers, and smartphones is conventional. Method 400 is implemented with downloadable software applications (app) installed on the smartphones, e.g., Android or iPhone apps.

Referring now to FIG. 4A, method 400 enrolls subscribers, accountholders, and users in a way that starts and proceeds conventionally. An enrollment process 412 directs the enrolling user to build a graphical persona 414 on their display that resembles them using a composite art drawing program. A persona descriptor library 416 and 418 allow simple choices of gender, age, race, hair, eyes, nose, chin, ears, and other limited categories. The choices within each category are standardized into 2-8 choices, for example.

In alternative embodiments of the present invention, matrix data is packed within a shape outline. For example, logos, silhouettes, and even rainbows or horses that are memorable and recognizable would be very useful.

As the enrolling user makes their choices, the graphical persona build 414 develops on their display screen and can be modified, edited, and corrected to suit their wishes. Once finished, the choices, and not the graphical persona itself are uploaded to the server 402 to become part of the user's profile. The graphical persona building is expected to be fun for the user, unlike typical enrollments that can be tedious and tiresome.

In FIG. 4B, method 400 is used to support in-field mobile transactions between previously enrolled subscribers, accountholders, and users. For example, the payment of an agreed amount of money in a retail purchase of goods at a store. The two users involved present at the same location are logged on to server 402, thereby excluding the vast majority of fraudsters. Both users begin by logging-in with server 402 using their respective smartphones 408 and 410.

Embodiments of the present invention are also useful for file transfers and local vault storage, not just financial applications. The inter-device and intra-device security technology described herein can be included on the front-ends of many applications.

When a first user with smartphone-1 408 requests a transaction and payment authorization, server 402 fetches corresponding persona descriptors 420 and embeds them in an encrypted colorgram 422. Such persona descriptors are represented as color cell data 424. Smartphone-1 408 decrypts and interprets the colorgram 422 and presents it on a visual display 426 with color cells 428.

The user of smartphone-2 410 receives payment and verification by imaging 430 visual display 426 and color cells 428 with its camera. Smartphone-2 410 presents the first user's graphical persona on display 432 using the descriptors to index a library 434. If the graphical persona resembles the first user, the second user sends an “OK” message 436 to the server 402.

In general, process embodiments of the present invention include pushing an encrypted video image from a transaction server over a network to a first personal trusted device. Then, a decryption of the video image is displayed on the first personal trusted device. A video image of that displayed on said first personal trusted device is captured with a camera of a second personal trusted device. An encryption of the image captured from the second personal trusted device is uploaded to the transaction server. An associated transaction between independent users respectively equipped with the first and second personal trusted devices is authenticated based on a comparison of the encrypted video image that was pushed to the first personal trusted device and what was uploaded from the second personal trusted device.

The pushing of the encrypted video image can include at least one coupon, advertising, and/or uniform resource locator (URL) link to the personal trusted device.

Other embodiments of the present invention can operate with even higher levels of security by collecting a type of biometric who-you-are security factor in addition to the what-you-have (smartphone) and what-you-know (passcode) security factors. This is what is represented in FIGS. 4A and 4B. In general, such embodiments include software and application programs to build a graphical persona or upload an image for identification.

If a smartphone has a public key pair installed, then there is inherent protection against man-in-the-browser, man-in-the-middle, Trojan horses attacks, and similar malware. One option is to encrypt the private key and store it encrypted under a colorgram key. The key for decrypting the private key is loaded into the smartphone from the colorgram as described herein, and the private key is recovered for a subsequent transaction, such as a signature generation or the decryption of received data. Anyone can then encrypt a message, file, or other transaction component with the corresponding public key and send it to the PTD of the owner of the private key and only the PTD can decrypt it with the corresponding said private key. Likewise, the user may generate a digital signature on a file or a financial transaction with said private key and forward it to another PTD or bank or whatever.

An alternative is to use a bit sequence from a colorgram as a cryptographic seed or initialization vector (IV), rather than a key, to initiate the generation of the private key on the phone every time a signature needs to be generated or a file needs to be decrypted. Additionally, the PTD may provide and additional seed stored permanently on the PTD The colorgram is then of no use to others because a separate seed is stored on the phone. Both are needed for key generation. Generating a public key pair from a seed is conventional, e.g., see Handbook of Applied Cryptography by Menezes, van Oorschot and Vanstone.

So stealing a smartphone would be useless, because the secret is not stored on the phone, not even in encrypted form. Conversely, stealing a colorgram is not enough either, as the seed in the colorgram cannot be used alone to generate the key.

A private key is nevertheless available on the smartphone to generate a digital signature. The first time it's generated, the public key may be registered with a Certification Authority, and a certificate may be issued according to existing standards such as X.509, EMV, etc.

To protect against future attacks on signature generation, more elaborate schemes may be applied, where the message to be signed is confirmed through a separate channel, such as a work station or another phone using, e.g., the technology described in United States Patent Application, US 2008/0307515 A1.

Colorgrams that change over time are a type of physical unclonable function (PUF). And so other manifestations of a PUF embodied in a token can be used instead. In general, a PUF is a physical embodiment that is easy to evaluate but hard to predict. But to be practical, PUF's must be inexpensive to manufacture but practically impossible to duplicate, even with the manufacturing process that produced the original. It is the hardware equivalent of a one-way function.

PUF's implement challenge-response authentication rather than embodying a single cryptographic key. PUF's react in an unpredictable ways to inputs because the physical microstructure of the device causes a complex interaction to stimulus. The exact microstructure depends on unpredictable physical factors introduced during manufacture. The stimulus applied is the challenge, and the reaction of the PUF to it is its response.

A specific challenge and its corresponding response together form a challenge-response pair (CRP). The device's identity is established by the microstructure's properties. Such structure is not fully revealed by the challenge-response mechanism, and so is resistant to spoofing attacks. PUF's can be implemented with inexpensive hardware that is proportional to the number of challenge and response bits.

A PUF is unclonable because each device has a unique and unpredictable way of mapping challenges to responses. Using the same process to make a similar device is not enough, because the manufacturing process cannot be exactly controlled. Each response is created by a complex interaction of the challenge with several random components. So, the CRP's are highly unpredictable.

Embodiments of the present invention comprise three basic elements: authentication, identification, and system functions. In authentication, the user is authenticated to the PTD by a colorgram with the key, and encrypted data that integrates user data and cryptographically generated passcodes for user URL sites is pushed by a server. Alternatively, PKI is used in an asymmetrical key system in which the colorgram is public in that it is data encrypted by a public key. Any loss of the colorgram, or the PTD, would not compromise its encrypted data, as the colorgram containing the data needed to reproduce the private key is necessary to access as well. Trojan Horses and most other malware could not compromise such encrypted data. But, PKI based systems require a lot of processing power from the PTD that may not be available in commercial devices for a few more years. Shifting colorgrams, e.g., chemical dye diffusions having a known reaction basis, or a PUF, are also included in some embodiments.

Most mobile transactions are debit or checking account related, not credit card related. So more of the risk of a fraudulent transaction is carried by the merchant. The use of personas in identification is a more pragmatic alternative to relying on merchants to ask to see a drivers license, passport, or other ID. It has value for the merchant in identifying the user in front of them, and not merely the authenticating of a possible user to a possible PTD. It can also be a “fun” consumer experience, and recognizes most consumers will not upload real photos of themselves for many reasons. So, building a persona with 5-10 identification points, e.g., hair color/style, eyes color and facial placement, skin color, facial geometry, male or female, facial hair, and other points, can be implemented with simple check boxes. Such selections can be used in a sub-routine to immediately copy the persona onto the merchants PTD.

Personas can be static, dynamic, animated with laughter, speaking words, or translate into something else after a few seconds. Alternatively, servers can accept uploaded photos and approximate personas from. The consumer experience should lead to early adoption, like ring-tones. The “face-tones” may become a big follow-on business by independent developers. The user experience needs to be more fun than a simple swipe, or push button. The consumer should be emotionally involved with their transaction process/system.

A system's architecture is needed to make everything work. Servers accept user data, e.g., URL and username and passcodes for their “secret” sites, financial sites identification that require an OTP, persona builds, and local device eWallet of Vaults that require a complex passcode, etc. The user data is added to server-generated data, e.g., OTP seeds/Initialization Vectors <IV>, for colorgram mapping, scatter plot in cell location and cell factorial integers, color primary values prior to any factorial math, auto-regeneration for passcode updates of user-defined sites on a user-defined temporal basis. The new colorgram keyed encrypted data strings are pushed directly to the phone using conventional protocols. The data is secured in the PTD's local secure data area, and the colorgram is printed, displayed on a device, stored on a device, or printed by a third party as a PUF and mailed to the user/consumer.

The server can recycle colorgrams by remapping them with the encrypted data string sequence sent to the phone, or the servers can generate an entirely new colorgram and associated mapping and encrypted data. Colorgrams can be printed, stored on any device with a display (iPod, etc.), or transmitted to only the other device during a transaction, or a request can be made via Internet http/SMS to transmit it to a third device. This allows an iPhone, for example, to display a colorgram. Such will work in a normal symmetrical key application, but an asymmetrical Public Key Infrastructure (PKI) method is preferable since the colorgram would be of no use to anyone else. Colorgrams can be “sequenced” by the phone stored encrypted code, so each transaction has a key extraction, and then a re-sequenced data string on the phone. The advantage is that stealing a phone code and its colorgram would render both useless, since the code would have sequenced to a new interpretation, based upon a stored algorithm, or a server-pushed seed for an existing algorithm. The encrypted code on the phone would be single-event evolving, and prior use would not be acceptable, as in a replay attack.

A transaction security process embodiment of the present invention includes authentication and identification parts for pushing an encrypted colorgram for user authentication and persona descriptors for user identification from a transaction server to a first personal trusted device. A decryption of the colorgram is displayed on the first personal trusted device. An image is captured by a second personal trusted device. An encryption of the image captured from the second personal trusted device is uploaded to the transaction server. The persona descriptors are used to build a composite rendering for identification of the first user to the second user. The second user clicks “OK” if they recognize the composite drawing as a reasonable persona of the first user.

In general, users set up new accounts by logging onto an Internet server and provide all the usual bits of information in a conventional interactive process. If a user is comfortable uploading a photo of themselves, they can do it. Otherwise, new users engage in a check-the-box procedure to build a composite-drawing persona. Each check box best describes such things as the user's gender, race, age, hair color and style, facial geometry, eye color, ears, etc. A persona build application, resident on the server, assembles composite-image datums that can be sent on demand later to the merchants for ID verification of particular users. An uploaded recent photo would be best, but few people will upload a photo because of personal security concerns. It may be that such persona building and use could spawn a new industry, much like ring-tones. People like to personalize their possessions.

Conventional facial compositing and other computer assisted face generation techniques include character generation for computer game art assets, personalized online “avatars”, photo fitting for helping witnesses identify criminal suspects, and character generation for 3D animations, comics, movies, etc. Such is very distinct from facial biometrics.

Conventional facial compositing and computer assisted face generation techniques concentrate on producing good visual likenesses to real world persons and to create striking and memorable avatars and characters from a range of possibilities which allow viewers to emotionally engage or identify with characters.

Biometrics concentrates on the measurement of body characteristics, such as measuring the distance between eyes, height of ears, proportions of the face, etc., at a level of measurement detail far beyond what an ordinary person perceives when looking at another's face. Which biometric characteristics to use are chosen in particular to be easy to acquire, but difficult to willfully change by facial expression or plastic surgery.

Self-generated facial composites do not necessarily convey an accurate likeness of the subject. Composites created by moving sliders to adjust features or through a directed iterative walk through random mutations is unlikely to result in a closely matching avatar. One alternative would be to generate the facial composite from a recent photo. If there is enough detail in the parameterization, it can essentially become a domain specific compression algorithm for the person's face.

Allowing users to choose their own avatars is unlikely to result a good likeness that a third person would immediately recognize. Working from a photo would be akin to implementing an efficient compression algorithm for facial data.

Facial compositing and biometrics can help during mobile electronic commerce or during face-to-face mobile transactions. In a case where each users mobile phone has connectivity online to a central server at the point of transacting, the users wish to be certain that they are transferring money from one to the other and not to a third party. The users can use their secure link via the central server to share a transaction identifier which both can display on a screen. In the simplest form this can be just a number. The number could be displayed in decimal on the screen, or it could be rendered as a pattern, or into an object from a set of well distinguished objects. It could also be rendered as a face.

Simple avatars can serve to distinguish amongst people with the same names posting in the same social community. Facial compositing is a fun alternative for people who would rather not post an actual photo of themselves, or who would like to construct a deliberately different alternate persona. But such could not be used to prevent one user from impersonating another. An attacker can simply choose a similar name and pick the same composited avatar, or just rip the image used straight off the site. Avatars have a role to play in preventing accidental confusion between parties, but do not provide much security.

A “secret face” can be constructed a photo or a composite of a person's real face that is unknown to attackers. A security protocol is needed in which the recipient of the transaction sends their face to the person about to make the payment in such a way that an attacker would not know which face to send at the time of receipt. But such an attacker would still be able to do a relay or masquerading attack. Facial images are trivial to copy.

Facial biometrics can be used in a mobile context to ensure that the person in front of a camera or sensor is really who they claim to be. Such biometrics can be measured by a computer and facial identification trials of bank cards with photos on the bank have proved conclusively that the typical lay person does very poorly at identifying whether the person standing in front of them is indeed the one in the photo. Even trained passport and border control staff are regularly fooled, hence one of the drivers for biometrics at border control. If the user is to authenticate themselves to their phone application using a facial image, attackers need simply hold up a photo of the real person to the camera. So there should be some live detection to prevent this ruse from succeeding.

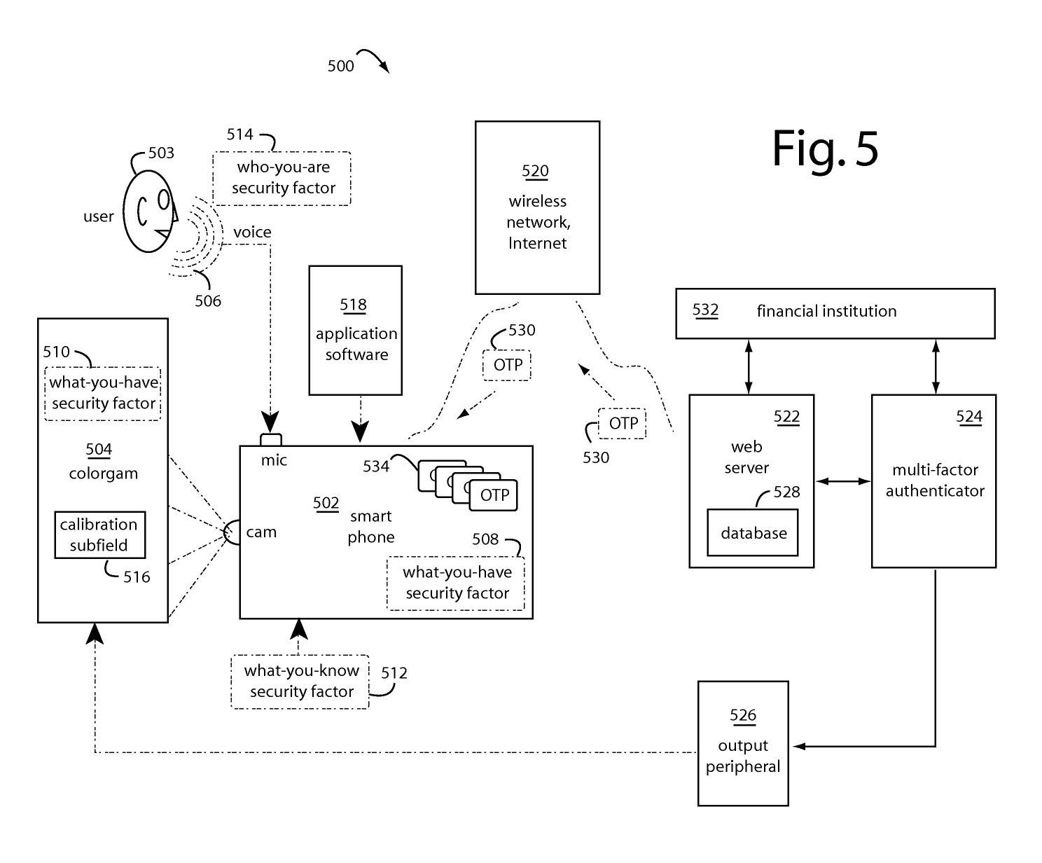

One Parent Application, now U.S. Pat. No. 8,224,293, issued Jul. 17, 2012, describes a colorgram. FIG. 5 represents on application of an encoded colorgram system, herein referred to by the general reference numeral 500. Such example demonstrates a practical and important use of the colorgram technology. A personal trusted device (PTD), such as a smartphone 502, is habitually carried by a user 503 with access to a visual key or colorgram 504. A camera included in the smartphone 502 is able to image the colorgram 504. A microphone can be called on to collect an audio sample of a user's voice 506 as a security factor.

Multi-factor authentication is provided by a what-you-have security factor 508 represented, e.g., by a SIM card in the smartphone 502, another what-you-have security factor 510 represented by the user's possession of colorgram 504, a what-you-know security factor 512 represented by a user's entry of a PIN, and a who-you-are security factor 514 represented by the user's voice 506. Some or all of these security factors can be collected in real-time and concatenated together to form a very long, very strong user authentication code.

The colorgram 504 may include various color marks and subfields 516 to assist in the image orienting, self-calibration, and interpretation of the color encoding carried by colorgram 504. Colorgram 504 includes visually encoded data in the form of colored cells from a standard palette of colors and arranged in a grid, radial pattern, matrix, or other pattern. The colored cells can be circles, squares, rectangles, ovals, or any other shape.

In one embodiment, a self-calibration subfield 516 includes a color cell from each of the standard palette of colors. If there are eight colors used in the standard palette, then there will be eight colored cells in the self-calibration subfield 516. These are arranged in a matrix in a standard way such that they can easily be recognized together as a self-calibration subfield 516 by an application software (app) 518 installed on the smartphone 502.

Environmental and product variations in the image capture of colorgram 504 with smartphone 502 can often produce large uncertainties in determining which colors in the standard palette of colors each colored cell in colorgram 504 represents. Application software 518 includes subroutines that register each of the color cells imaged in self-calibration subfield 516 as the possible choices, and each color cell from the colorgram 504 is compared to test which standard color is the closest match. The decisions can be reached quickly and with very few reading errors.

A determination of which color from the standard palette of colors is represented by each color cell in colorgram 504 can be ascertained by mapping all the colors visualized and finding any available correlations that exist amongst them.

User 503 and smartphone 502 may authenticate themselves through a wireless network 520 to a webserver 522. A multi-factor authenticator 524 can pre-issue credentials like colorgram 504 printed by a printer or other output peripheral 526. When the concatenated user authentication code is returned through webserver 522, that portion representing the what-you-have security factor 510 can be verified by multi-factor authenticator 524. A database 528 maintains a list of accounts and single-use-codes or one-time-passwords (OTP) 530 authorized by a financial institution 532, for example. A short-term supply of OTP's 534 is stored within smartphone 502 for use later when the network 520 is inaccessible.

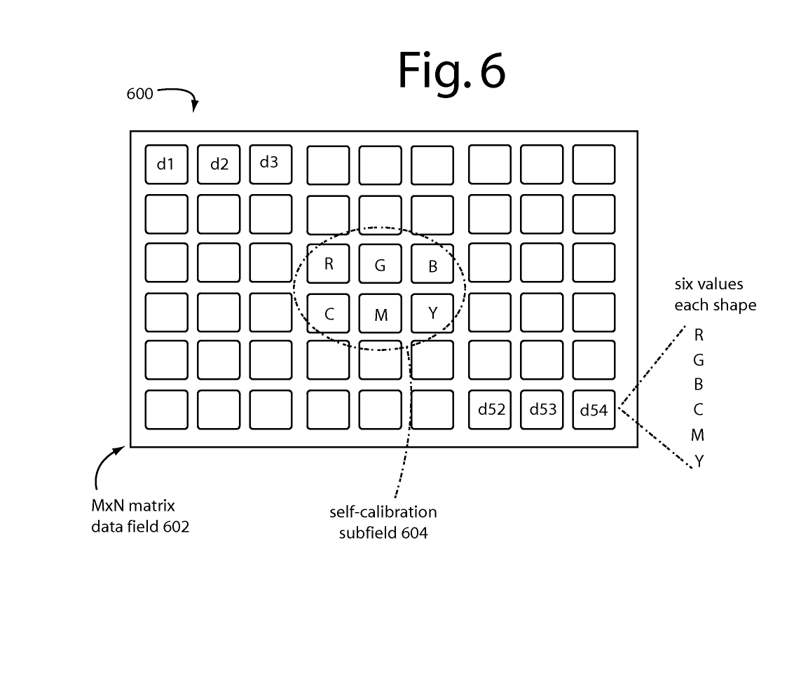

FIG. 6 represents a colorgram embodiment of the present invention, and is referred to herein by the general reference numeral 600. Colorgram 600 includes, in this example, a rectangular 9×6 matrix data field 602 decorated with a predetermined physical pattern of colored cells d1-d54. The variety of colors is limited to a finite set of colors in discrete steps. The whole is arranged and configured so that a digital camera in the PTD can image of all the colored cells d1-d54 at once. The choice of colors of each colored cell d1-d54 and its location within the predetermined physical pattern of matrix data field 602 is capable of encoding data.

A subfield 604 of colored cells is chosen to serve as a calibration subfield, and are disposed in an standardized place in the data field and a standardized choice of colors of each colored cell from the finite set of colors in discrete steps and a standardized location within the subfield. In this example, red-green-blue-cyan-magenta-yellow (R, G, B, C, M, and Y). All the other color cells d1-d54 which encode data must be one of these colors, and a processor using a camera to image matrix data field 602 can rely on this rule to speed recognition of the data encoded in colorgram 600.

The example of FIG. 6 uses six standard colors. If eight colors were the standard, each colored cell d1-d54 could be used to represent a 3-bit binary, 0-7 decimal. More colors and larger matrix sizes can be used to encode more data, but the limits are reached by the camera's abilities to resolve the cells and their colors within a larger matrix, or smaller matrix with smaller individual cells.

The calibration subfield 604 serves as a means to orient and synchronize the encoded data present in matrix data field 602. Such data is visually encoded into the data field as (1) a particular step in one of the color spots in the finite set, and (2) in respective locations within the matrix data field 602. Each place in the matrix data field 602 can carry a different weight, meaning, or act as a data definition. Reading the encoded data can begin with colored cell d1 and end with d54, for example. It is entirely possible, of course, to encode arbitrary data such as Internet Uniform Resource Locators (URLs), user information, file names, and other data.

In restaurants it is very common for a waiter to present a written bill and to expect the customer to leave their credit card on a tray as payment. The waiter disappears with it all and reappears sometime later with a credit charge authorization to sign. No telling what happened with the card while it was gone.

The above described embodiments would ordinary mean that a waiter in a restaurant would have to be given the smartphone so their terminal could be used to scan the colorgram or QR-Code. This, of course, would be unacceptable. So, an alternative embodiment is described below that solves this particular problem.

In a restaurant guest payment system 700, after a meal a guest asks a waiter for a food check for the services and stipulates their preferred payments vendor, e.g., MASTERCARD, VISA, DINERS CLUB, DISCOVER, etc. The waiter disappears to prepare a bill or food check 702 which is presented in hardcopy with an itemization 704, a total 706, and a colorgram or QR-Code 708.

The waiter uses a merchant point-of-sale (POS) terminal or tablet 710 which is provided with an app 712 in a downloadable and executable embodiment of the present invention. The tablet 710, under the direction of app 712, engages the help of an inventory control system 714 to enter purchase information and payments preferences. A running tab or tally 716 is accessed to build a total and to adjust inventories. A wireless link 718 is used to enable mobility. A printer 720 is sent the job of printing out check 702. This then can be delivered by the waiter to the consumer or guest.

The QR-Code 708 embeds, for a restaurant example, a merchant identification code, the preferred payments vendor, table number, server ID, other payment routings, purchase itemization, and total charges. These are embedded in an encrypted bill message 722 to a selected payments processor 724.

The particular payments processor 724 is selected according to the preference that was originally stated by the guest, MASTERCARD, VISA, DINERS CLUB, DISCOVER, etc. The selected payments processor 724 is authorized to deal with a corresponding issuing bank 726. A special application program 727 is installed to control and enable the herein described proprietary interactions with merchant app 712 and user app 730.

The selected payments processor 724 sends a bill-has-been-presented message 728 to the corresponding issuing bank 726. At this point, neither the merchant nor the payments processor 724, nor the issuing bank 726 have been informed of the identity of the consumer. The bill-presented message 728 includes, at least, transaction total, itemization, merchant identification, and merchant account information over a secure channel. The hardcopy food check 702 essentially embeds the same information.

A user app 730 in an embodiment of the present invention to cooperate with app 712, is downloaded and installed on a mobile smartphone 732. When the user is presented with food check 702 at their table, the user initiates an optical scan 734 to fetch food check image 736. Such image 736 can be encrypted and not entirely readable by smartphone 732. But it would be best, at the very least, if app 730 could verify to the user the amount of the transaction that they are being asked to authorize.

The food check image 736 is sent in whole or in abstract in a payment request message 738 to issuing bank 726. Such payment request message 738 not only includes all the information the merchant printed in food check 702, but all the user identification information needed by the issuing bank 726 to find the user's account in a relational database 740.

The issuing bank 726 may respond with a message 742 asking for a password, confirmation, or just a transaction summary for the user to approve. A preselected standard tip can be automatically calculated. A user approval and/or password 744 are returned, along, for example, with an amount to add in as a tip. A bill-paid message 746 is returned to the payments processor 724 identifying which bill has been paid and how much was paid.

The user is free to get up and leave when a payment-complete message 748 is delivered to smartphone 732. The waiter cannot hang up the guest's departure by inattention. Such payment-complete message 748 can include a payment confirmation number or message as a receipt and legal proof-of-payment.

The issuing bank 726 can further respond to the payments processor 724 with a guest ID or security factors. For example, with a string that reads, “Mr. Jones has been your guest today for the twenty-seventh time.” Or the guest can remain completely anonymous to all but the issuing bank 726.

The bill-paid message 746 returned to the payments processor 724 is forwarded in a guest-has-paid-the-bill message which ultimately gets displayed on tablet 710 and registered with inventory controller 714.

In another aspect of the present invention, the merchants ring up the charges on a POS terminal and print out receipts that display the amount-to-pay and a machine readable bar code which encodes the merchant's name, any bank routing information, table or guest number, and any coupon information.

Each consumer uses their smartphone camera to upload the bar code presented. A mobile device resident user app is launched in the smartphone to extract the encoded information. A PIN or other parametric/biometric entry is requested. Any gratuity or discount coupons are applied, and the app authorizes a transfer of money from their registered account to the merchant's account. A transaction receipt is sent directly to the merchant.

One advantage of these embodiments is the payment cards and funding sources are not necessarily revealed or exposed to the merchant. As was always the case when cash was used in the past. Each consumer retains control of the payment process. These payments can be done anywhere in the merchant's facility, at any time, and without having to queue in lines or wait for clerks.

These embodiments are expected to work equally as well in Apple stores where the clerks roam about with mobile POS terminals, and in more traditional and conventional restaurants. In restaurant scenarios, a seating location graphic is displayed to show which tables are occupied and which are open. The table location of the particular consumer is identified in the above mentioned bar code. Each payment completion is flagged on the screen, to let the waiters know who's checks were paid before the consumer can leave the restaurant.

In yet another embodiment, the merchant bar code information is printed on their menus, on a graphic at the POS, and any other prominent location. Consumers can then scan any of these to prepare a payment transfer before the actual purchase.

Home Depot, Lowes, and other retail stores allow their customers to check out themselves. While shopping, the consumer scans items and pays for each. Their physical shopping cart may be equipped a bar code to identify them as they depart the store, and to allow security checks that they have the correct number of items and have made payment.

Many items in future are expected to have near-field communication (NFC) tags. These NFC tags can be scanned by users and by merchants to confirm correct payment has been made on each item in their possession. Such can help reduce consumer fraud wherein a cheap item is used to hide a more expensive item. If the merchant has an automated scanning system for the NFC tags, then the price and items bought can be correlated as the consumer exits the store. The advantage is faster check-out for the consumer and fewer checking staff for the merchant, especially during peak shopping days/hours.

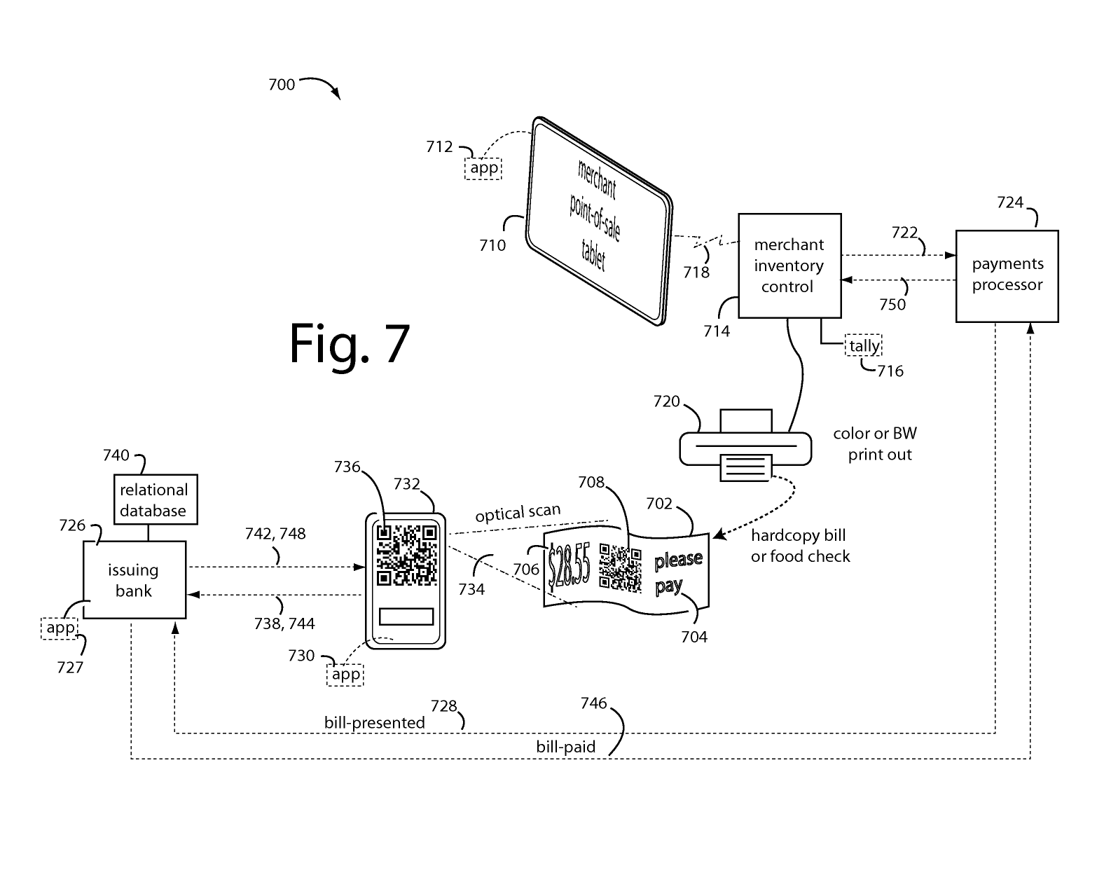

Referring still to FIG. 7, system 700 can be adapted to online sales and card-not-present transactions. The bill 702 need not be printed and is sent as a graphic to an online user at a remote location. The user either images it with their smartphone 732 or uploads it. App 730 is not concerned with any actual real presence at the merchant's location, unless that is deliberately included as a security factor. Smartphone GPS functions can be involved for geo-fencing, e.g., the user is actually present at the merchant's registered location. All else proceeds as described above.

In practice, almost any machine-readable, screen-displayable, or printable artifact or graphic can substitute for the matrix barcodes described herein. Steganographic images and codings are useful as well. However, the use of standardized types of matrix barcodes, like QR-Codes, have the advantage of being able to leverage economic and commercially available equipment and software.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A payment system for allowing a consumer user with a smartphone to electronically pay for purchases presented to a merchant point-of-sale terminal for tally and checkout, comprising:
a mobile app configured to display a matrix barcode on a smartphone display as a payment token and that encodes a temporary reference index provided by an issuing bank;
a payments processing application configured to provide said matrix barcode to the mobile app on request of a consumer user, and configured to be hosted by an issuing bank or payments processor;
a merchant point of sale (POS) application configured to accept an optical scan of said matrix barcode from said smartphone display as an offer of electronic payment, and configured to communicate with an issuing bank or payments processor;
wherein, said temporary reference index is formatted together with a tally of purchases and a bill total to be paid by the POS application, and is configured to forward such through a network to the payments processing application.

2. The payment system of claim 1, wherein:
the mobile app is further configured to receive a request from the payments processing application to confirm or deny said offer of electronic payment.

3. The payment system of claim 1, wherein:
the mobile app is further configured to send transaction ratifications to the payments processing application to confirm or deny said offer of electronic payment.

4. The payment system of claim 1, wherein:
the mobile app is further configured to preregister itself, the consumer user, and user devices with the payments processing application for use later as security factors in user authentications.

5. The payment system of claim 1, wherein:
the mobile app is further configured print said matrix barcode as said payment token on a matrix barcode check; and
the POS application is configured to optically scan said matrix barcode check as said offer of electronic payment.

6. The payment system of claim 1, wherein:
the payments processing application is configured to encode said matrix barcodes with unique numbers associated in a relational database with a user account number and to keep such association in a secure environment; and
the payments processing application is further configured to recover said user account number from a matrix barcode forwarded by the POS application as said offer of payment with support from said relational database.

7. The payment system of claim 1, wherein:
said matrix barcodes comprise colorgrams configured as an M×N matrix of color encoded cells that constitute a three dimensional (3D) matrix barcode.

8. A payment system for allowing a consumer user with a smartphone to electronically pay for purchases presented to a merchant point-of-sale terminal for tally and checkout, comprising:
a colorgram configured as an M×N matrix of color encoded cells that constitute a three dimensional (3D) matrix barcode;
a mobile app configured to display said 3D matrix barcode on a smartphone display as a payment token and that encodes a temporary reference index provided by an issuing bank;
a payments processing application configured to provide said 3D matrix barcode to the mobile app on request of a consumer user, and configured to be hosted by an issuing bank or payments processor;
a merchant point of sale (POS) application configured to accept an optical scan of said 3D matrix barcode from said smartphone display as an offer of electronic payment, and configured to communicate with an issuing bank or payments processor;
wherein, said temporary reference index is formatted together with a tally of purchases and a bill total to be paid by the POS application, and is configured to forward such through a network to the payments processing application;
wherein, the mobile app is further configured to receive a request from the payments processing application to confirm or deny said offer of electronic payment, and configured to send transaction ratifications to the payments processing application to confirm or deny said offer of electronic payment, and is configured to preregister itself, the consumer user, and user devices with the payments processing application for use later as security factors in user authentications.

9. The payment system of claim 8, wherein:
the mobile app is further configured print said 3D matrix barcode as said payment token on a 3D matrix barcode check; and
the POS application is configured to optically scan said 3D matrix barcode check as said offer of electronic payment, and to interpret each color in each cell as belonging to a standard palette of colors and as carrying an encoding of information.

10. The payment system of claim 8, wherein:
the payments processing application is configured to encode said 3D matrix barcodes with unique numbers associated in a relational database with a user account number and to exclusively maintain such association in a secure environment; and
the payments processing application is further configured to recover said user account number from a 3D matrix barcode forwarded by the POS application as said offer of payment with support from said relational database;
wherein, each color in each cell of the colorgram is interpreted as belonging to a standard palette of colors.

11. A method of retail electronic payment at a merchant point-of-sale (POS) terminal, comprising:
storing an association of a consumer account number, a password, a pre-registration of user devices, and a temporary transaction identification index in a relational database in a secure environment;
issuing said temporary transaction identification index encoded as a matrix barcode to a user on request through a network from a user device already preregistered;
using a display of said matrix barcode by a user as a method of payment at a merchant POS terminal;
extracting said temporary transaction identification index encoded in said matrix barcode displayed by the user;
attaching a data message representing a bill for purchases, said temporary transaction identification index that was extracted, and a merchant ID in combination, and forwarding said data message over a network for payment authorization;
receiving said data message in said secure environment and using said temporary transaction identification index to fetch said user account number for authorization and debit of said bill of purchases;
electronically contacting any one of said pre-registered user devices to require the user to validate of said method of payment being proposed at said merchant POS terminal; and
approving or declining said method of payment being proposed at said merchant POS terminal based on password and user authentication, and on user validation.

12. The method of claim 11, further comprising:
printing said matrix barcode on a check; and
scanning said check as a form of payment.

13. A restaurant guest payment system, comprising:
a user app configured to be downloaded and executed by a mobile smartphone;
a merchant app configured to be downloaded and executed by a merchant point-of-sale (POS) tablet;
wherein the POS tablet has access to a printer able to produce a hardcopy of a food check for presentation to a guest on demand;
wherein the mobile smartphone is equipped to image said hardcopy of a food check and to access an issuing bank for electronic payment;
wherein the merchant app is configured to contact said issuing bank with a request-for-payment message;
wherein the user app is configured to forward an image or abstract of the food check to the issuing bank to authorize payment from a user account;
wherein the merchant app is configured to receive a bill-paid message from the issuing bank that will release the user as said guest.
